(19) United States
(12) Patent Application Publication
(10) Pub. No.: US 2026/0059316 A1
(43) Pub. Date: Feb. 26, 2026

(54) BEAM MANAGEMENT FRAMEWORK WITH MACHINE LEARNING AND MODEL TRANSFER

(71) Applicant: APPLE INC., Cupertino, CA (US)

(72) Inventors: Weidong Yang, San Diego, CA (US); Hong He, San Jose, CA (US); Dawei Zhang, Saratoga, CA (US); Wei Zeng, San Diego, CA (US); Huaning Niu, San Jose, CA (US); Ankit Bhamri, Bad Nauheim (DE); Oghenekome Oteri, San Diego, CA (US)

(21) Appl. No.: 19/107,113

(22) PCT Filed: Sep. 8, 2023
(86) PCT No.: PCT/US2023/073738

§ 371 Date: Feb. 27, 2025

Related U.S. Application Data
(60) Provisional application No. 63/376,858, filed on Sep. 23, 2022.

(51) Int. Cl. H04W 12/106; G06N 3/08; H04W 8/24; H04W 72/23

(52) U.S. Cl. CPC H04W 12/106; G06N 3/08; H04W 8/24; H04W 72/23

(57) ABSTRACT

Methods and apparatus are provided for beam management with machine learning. A user equipment (UE) receives, from a wireless network, one or more physical downlink shared channel (PDSCH) including data for a neural network (NN) model for beam management. The UE verifies an integrity of the NN model received from the wireless network and determines a UE capability to support the NN model received from the wireless network. In response to verifying the integrity and determining the UE capability to support the NN model, the UE transmits a NN model transfer complete acknowledgement to the wireless network.

### TECHNICAL FIELD

This application relates generally to wireless communication systems, including beam management.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an encoder and a decoder in a CSI feedback operation according to certain embodiments.

FIG. 2 is a signaling diagram illustrating UE-side model training and UE-side inference according to certain implementations.

FIG. 3 is a signaling diagram illustrating NW-side model training and NW-side inference according to certain implementations.

FIG. 4 is a signaling diagram illustrating NW-side model training and UE-side inference according to certain implementations.

FIG. 5A and FIG. 5B are signaling diagrams illustrating model activation timing according to certain embodiments.

FIG. 6 is a flowchart of a method for a UE to communicate in a wireless network according to one embodiment.

FIG. 7 is a flowchart of a method for a base station in a wireless network to configure beam management according to one embodiment.

FIG. 8 illustrates a timeline to start downloading a NN model to a UE in anticipation of a handover according to one embodiment.

FIG. 9 is a signaling diagram illustrating transfer and activation of a NN model during handover according to one embodiment.

FIG. 10 is a signaling diagram illustrating transfer and activation of a NN model during handover according to one embodiment.

FIG. 11 is a flowchart of a method for a UE to communicate in a wireless network according to one embodiment.

FIG. 12 is a flowchart of a method for a base station to communicate with a UE in a wireless network according to one embodiment.

FIG. 13 illustrates an example architecture of a wireless communication system, according to embodiments disclosed herein.

FIG. 14 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network (NW) and is configured with the hardware, software, and/or firmware to exchange information and data with the NW. Therefore, the UE as described herein is used to represent any appropriate electronic component.

Downlink channel state information (CSI) (e.g., for frequency division duplex (FDD) operation) may be sent from a UE to a base station through feedback channels. The base station may use the CSI feedback, for example, to reduce interference and increase throughput for massive multiple-input multiple-output (MIMO) communication. However, such feedback uses excessive overhead. Vector quantization or codebook-based feedback may be used to reduce feedback overhead. The feedback quantities resulting from these approaches, however, are scaled linearly with the number of transmit antennas, which may be difficult when hundreds or thousands of centralized or distributed transmit antennas are used.

Artificial intelligence (AI) and/or machine learning (ML) may be used for CSI feedback enhancement to reduce overhead, improve accuracy, and/or generate predictions. AI and/or ML may also be used, for example, for beam management (e.g., beam prediction in time/spatial domain for overhead and latency reduction and beam selection accuracy improvement) and/or positioning accuracy enhancements.

CSI feedback using AI and/or ML may be formulated as a joint optimization of an encoder and a decoder. See, e.g., Chao-Kai Wen, Wan-Ting Shih, and Shi Jin, “Deep Learning for Massive MIMO CSI Feedback,” IEEE Wireless Communications Letters, Volume 7, Issue 5, October 2018. Since this early paper by Chao-Kai Wen, et al., auto-encoders and many variations have been considered. Image processing/video processing technology have been used for CSI compression, which can be natural choices considering the latest wave of ML applications in image processing/video processing. Further, when formulated in the right domain, CSI feedback bears similarities to images/video streams.

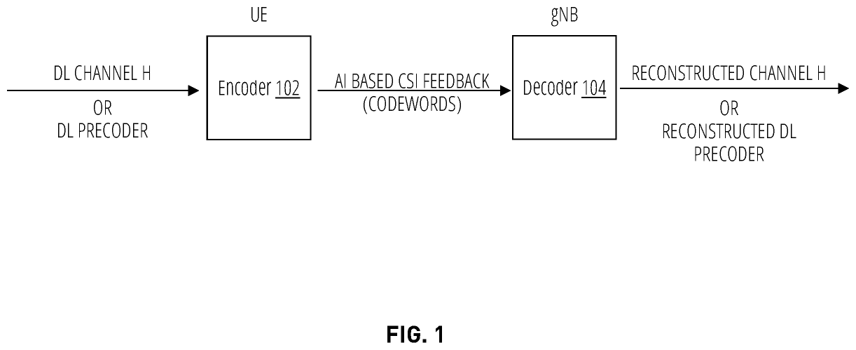

At a high level, FIG. 1 illustrates an encoder 102 of a UE and a decoder 104 of a base station (e.g., gNB) in an AI based CSI feedback operation according to certain embodiments. As shown, the encoder 102 receives a downlink (DL) channel H and outputs AI based CSI feedback. The encoder 102 learns a transformation from original transformation matrices to compressed representations (codewords) through training data. The decoder 104 learns an inverse transformation from the codewords to the original channels. Thus, the decoder 104 can receive the AI based CSI feedback (codewords) from the encoder 102 and output a reconstructed channel H. End-to-end learning (e.g., with an unsupervised learning algorithm) may be used to train the encoder 102 and the decoder 104. Typically, normalized mean square error (NMSE) or cosine similarity is the optimization metric. In some designs, the DL channel H can be replaced with a DL precoder. Hence, the encoder 102 takes the DL precoder as input and generates AI based CSI feedback and the decoder 104 takes the AI based CSI feedback and reconstructs the DL precoder.

Various types of neural network (NN) encoders/decoders can be trained for different purposes, with different tradeoffs of complexity, overhead, and performance. A convolutional neural network (CNN) may, for example, be used for CSI feedback for frequency and spatial domain CSI reference signal (CSI-RS) compression. Other examples include using a transformer or a generative adversarial network (GAN). Depending on number of receive antennas and rank, either channel feedback or precoding matrix indicator (PMI) feedback can be used. For example, with four receive antennas, rank 1 and rank 2 feedback may potentially use AI NN trained with an eigenvector as input, whereas rank 3 and rank 4 can potentially use channel state information as input to a trained AI NN. Data preprocessing can be used on input of an AI model. Preprocessing from frequency domain to time domain may be used and some of the small paths may be removed before input to the AI NN. A maximum rank indicates a maximum number of layers per UE, which corresponds to a lack of correlation or interference between the UE's antennas. For example, rank 1 corresponds to a maximum of one spatial layer for the UE, rank 2 corresponds to a maximum of two spatial layers for the UE, rank 3 corresponds to a maximum of three layers for the UE, and rank 4 corresponds to a maximum of four layers for the UE.

CNN+RNN (recurrent NN) based NN may be used for time domain, frequency domain, and spatial domain CSI-RS compression. The input may be a time sequence with a set of CSI-RS configurations. A preprocessed time sequence such as frequency domain pre-processing (to time domain and removing small channel taps), and Doppler domain preprocessing can also be applied as AI input. Angular domain preprocessing is also possible, however, angular domain preprocessing may not be efficient in certain implementations.

There may be a perceived difference between AI for CSI and IA for beam management (BM). For CSI feedback, the encoder and decoder may be located at different nodes (UE and gNB). See, e.g., FIG. 1. For beam management, some have proposed using a single sided model should be used, wherein the AI model is more or less an implementation specific design. For example, if the AI model is located at the UE, then training and inference is performed at UE/by UE. If, on the other hand, the AI model is located at the gNB, then training and inference is performed at gNB/by gNB. Assistance information may be used in certain implementations. For example, through internal investigation, it is found that the loading with direct Fourier transform (DFT) beams can be unequal. Thus, there may be a need to improve or optimize the analog beam design, which may no longer be amenable for a description with DFT precoding.

At least two sets of beams may be associated with NN models. Set A includes beams for which the NN model generates prediction. Set B includes beams that are measured and the measurements used as inputs to the NN model.

In certain systems, for AI/ML-based beam management, support is provided for BM-Case1 and BM-Case2 for characterization and baseline performance evaluations. BM-Case1 includes spatial-domain DL beam prediction for Set A beams based on measurement results of Set B of beams. BM-Case2 includes temporal DL beam prediction for Set A beams based on the historic measurement results of Set B beams. For BM-Case1 and BM-Case2, Beams in Set A and Set B can be in the same frequency range.

For sub use case BM-Case1, two alternatives (Alt.1 and Alt.2) may be considered. Alt.1 is AI/ML inference at NW side and Alt.2 is AI/ML inference at UE side. Similarly, for sub use case BM-Case2, Alt.1 and Alt.2 may be considered, where for Alt.1 AI/ML inference is at NW side and for Alt.2: AI/ML inference is at UE side. In certain implementations, regarding the sub use case BM-Case2, the measurement results of K (K>=1) latest measurement instances may be used for AI/ML model input (the value of K is up to particular implementations). In certain implementations, regarding the sub use case BM-Case2, AI/ML model output may include F predictions for F future time instances, where each prediction is for each time instance (at least F=1, with other value(s) of F is up to particular implementations). As used herein, AI model, ML model, and/or NN model may be used interchangeably.

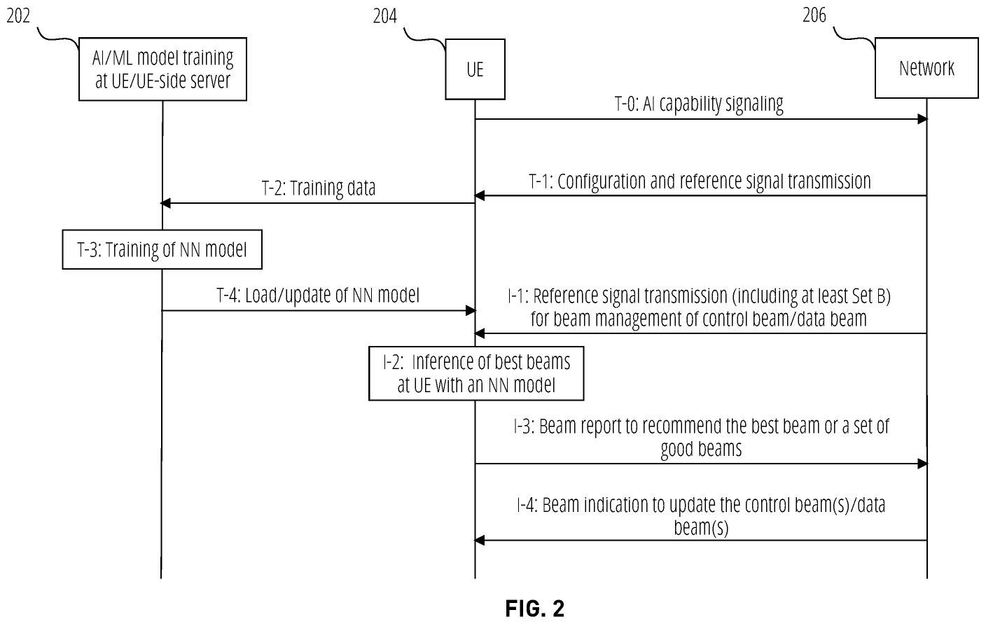

FIG. 2 is a signaling diagram illustrating UE-side model training and UE-side inference according to certain implementations. The example shows training steps (T-steps) and inference steps (I-step). However, skilled persons will recognize from the disclosure herein that the steps can be performed in a different order than that shown and that there may not be strict chronological requirements between the T-steps and the I-steps.

In a training step T-0, a UE 204 sends AI capability signaling to a network 206. In a training step T-1, the network 206 responds by sending a configuration and reference signal transmission to the UE 204. In a training step T-2, based on the configuration and measurements of the reference signal, the UE 204 generates and provides training data for AI/ML model training 202. In a training step T-3, the UE or UE-side server performs training of an NN model. In a training step T-4, the UE or UE-side server loads or updates the trained NN model into an NN engine of the UE.

In an inference step I-1, the network 206 sends reference signal transmission (including at least Set B) for beam management of one or more control beam and/or data beam. In an inference step I-2, the UE 204 performs an inference of best beams at the UE with the trained NN model. In an inference step I-3, the UE 204 sends a beam report to the network 206 to recommend the best beam or a set of good beams. In an inference step I-4, the network 206 sends a beam indication to update the control beam(s)/data beam(s).

In this example, the AI/ML model training 202 and inference is performed at a UE 204 or a UE-side server. Thus, analog beam design information may be embedded in the training data from T-1 already. Thus, no extra assistance information may be needed about the analog beams. However, for different infrastructure vendors, even modules of different types from the same infrastructure vendor, or different field operations, administration, and maintenance (OAM) configurations for the same type of modules, the analog beam design may be different. Thus, the trained model is likely to be site-specific. Further, considering that different modules may be used for different bands at the same site under the same operator, the trained model may be band-specific. In existing systems, it is not clear how a UE-side server can achieve such training.

For example, if the trained model is site-specific and band-specific, then with UE mobility, frequent model update or model switching may be needed. In a case for “model update,” the storage for AI model(s) at a UE may be limited, hence when a UE moves to a new cell, real-time loading a new AI model (with new weights) from the UE-side server may be needed. In a case for “model switching,” the storage for AI model(s) at a UE is large enough, hence when a UE moves to a new cell, a new AI model (with new weights) that is stored at the UE already is switched on. Thus, there may be need to load new AI model(s) into the UE from UE-side server, but that may not be executed in real-time. Compared with the issue to train site-specific/band-specific models, the logistics of model transfer may be less of an issue.

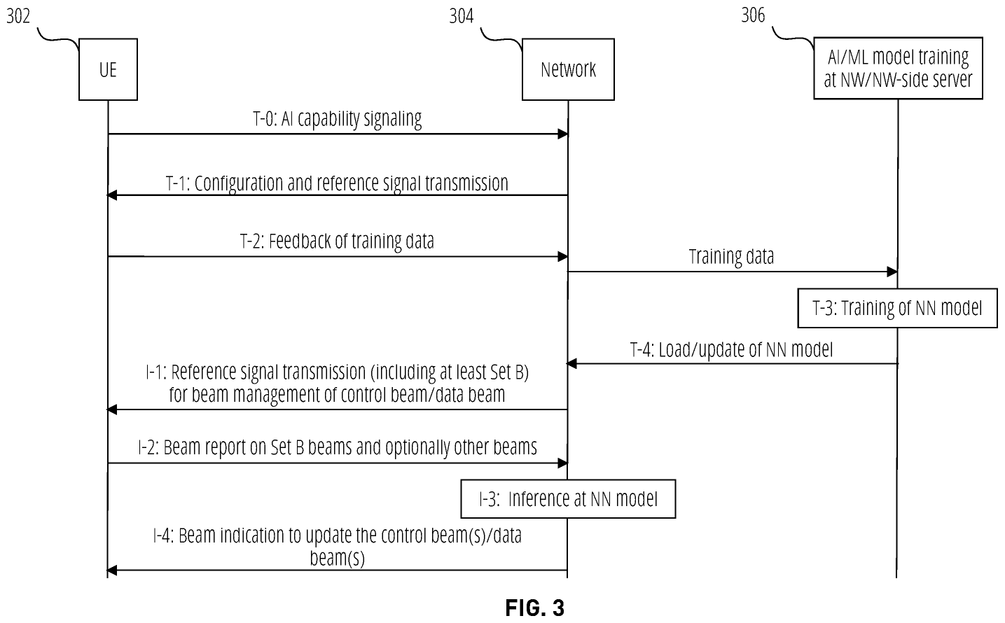

FIG. 3 is a signaling diagram illustrating NW-side model training and NW-side inference according to certain implementations. As indicated above, skilled persons will recognize from the disclosure herein that the steps can be performed in a different order than that shown and that there may not be strict chronological requirements between the T-steps and the I-steps.

In a training step T-0, a UE 302 sends AI capability signaling to a network 304. In a training step T-1, the network 304 responds by sending a configuration and reference signal transmission to the UE 302. In a training step T-2, based on the configuration and measurements of the reference signal, the UE 302 generates and sends training data to the network 304, which the network 304 provides to AI/ML model training 306 at the NW or NW-side server. In a training step T-3, the NW or NW-side server performs training of an NN model. In a training step T-4, the NW or NW-side server loads or updates the trained NN model into an NN engine of the network 304.

In an inference step I-1, the network 304 sends reference signal transmission (including at least Set B) for beam management of one or more control beam and/or data beam. In an inference step I-2, the UE 302 sends a beam report on Set B beams and optionally other beams to the network 304. In an inference step I-3, the network 304 performs an inference with the trained NN model to infer transmit beams to send to the UE 302. In an inference step I-4, the network 304 sends a beam indication to the UE 302 to update the control beam(s)/data beam(s).

In this example, with NW-side model training and NW-side inference, it is possible that analog beam design information is embedded in the training data already. Thus, the illustrated beam management procedure may be useful, and enhancements may be limited to T-2 (e.g., increasing the number of reported beams). However, the example shown in FIG. 3 may increase feedback overhead. For example, prior to the inference step I-4, if the network 304 is unsure of the inferred transmit beams, the network 304 may transmit a number of candidate beams from Set A to the UE 302, and the UE 302 may report the corresponding references signal received powers (RSRPs) or the best transmit beam back to the network 304. Similarly, for the UE-side example shown in FIG. 2, the same need for increased overhead may arise.

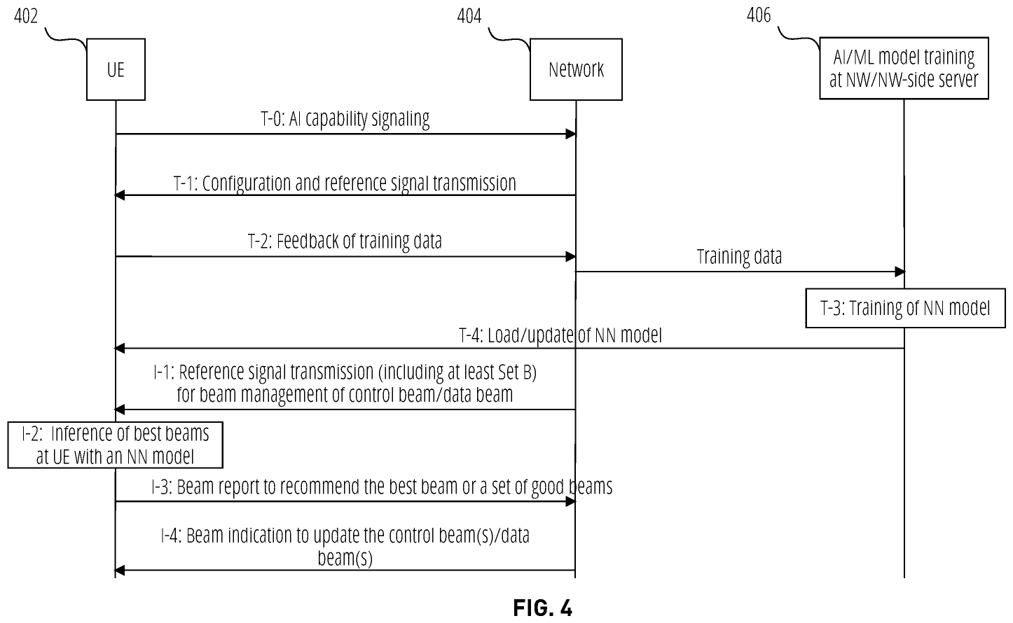

FIG. 4 is a signaling diagram illustrating NW-side model training and UE-side inference according to certain implementations. As indicated above, skilled persons will recognize from the disclosure herein that the steps can be performed in a different order than that shown and that there may not be strict chronological requirements between the T-steps and the I-steps.

In a training step T-0, a UE 402 sends AI capability signaling to a network 404. In a training step T-1, the network 404 responds by sending a configuration and reference signal transmission to the UE 402. In a training step T-2, based on the configuration and measurements of the reference signal, the UE 402 generates and sends feedback of training data to the network 404, which the network 404 provides to AI/ML model training 406 at the NW or NW-side server. In a training step T-3, the NW or NW-side server performs training of an NN model. In a training step T-4, the NW or NW-side server sends the trained NN model to the UE 402 (e.g., in a direct link from the NW-side server to the UE) to load or update the trained NN model into an NN engine of the UE 402.

In an inference step I-1, the network 404 sends reference signal transmission (including at least Set B) for beam management of one or more control beam and/or data beam. In an inference step I-2, the UE 402 performs an inference of best beams at the UE 402 with the trained NN model. In an inference step I-3, the UE 402 sends a beam report to recommend the best beams or a set of good beams to the network 404. In an inference step I-4, the network 404 sends a beam indication to the UE 402 to update the control beam(s)/data beam(s).

In this example, with NW-side model training and UE-side inference, it is possible that analog beam design information is embedded in the training data from T-1 already. Thus, the illustrated beam management procedure may be useful, and enhancements may be limited to T-2 (e.g., increasing the number of reported beams). However, the example shown in FIG. 4 may increase feedback overhead. For example, prior to the inference step I-4, if the network 304 is unsure of the inferred transmit beams, the network 404 may transmit a number of candidate beams from Set A to the UE 402, and the UE 402 may report the corresponding references signal received powers (RSRPs) or the best transmit beam back to the network 404.

Conceptually, deducing the best transmit beam is possible, assuming there is no abrupt change in the two dimensional (2D) plane or the data itself. In certain implementations, 2D data may lead to a better NN model. In an example use case, a shallow network or NN with four layers may produce good results, in contrast to AI for CSI where transformers have been considered. In certain implementations, the AI model size may not be too large and frequent model transfer may be feasible.

Thus, in certain embodiments disclosed herein, the network trains an AI model for a single cell or multiple cells. In one embodiment, an AI model for a single cell is associated with a physical cell identifier (PCI). In another embodiment, an AI model for a single cell is associated with multiple transmission reception points (mTRP). In addition, or in other embodiments, an AI model for multiple cells can be associated with cells with different geographical coverages. In addition, or in other embodiments, an AI model for multiple cells can be associated with cells in the same band.

In certain embodiments, upon a UE entering a connected mode, the UE can receive an AI model from the network for a single cell or multiple cells. In one embodiment, the UE derives RSRP or beam indices with the AI model. In addition, or in other embodiments, the UE may be configured by network to monitor the performance of the AI model.

In certain cellular systems, with both NW-side training/inference and UE-side training/inference, even NW-side training/UE-side inference or UE-side training/NW side inference when generalization of the model not deemed serious, model transfer either never takes place or happens infrequently. Now, with the understanding of analog beam design and difficulties expected for generalization, frequent model transfer may be triggered. Thus, there is a need to account for the timing of model activation (i.e., model activation latency).

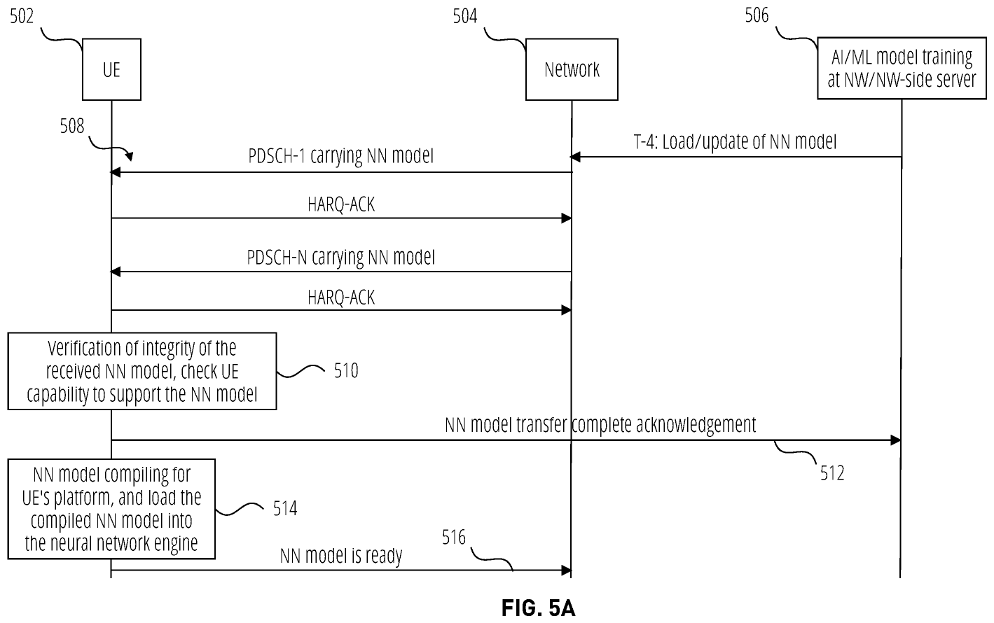

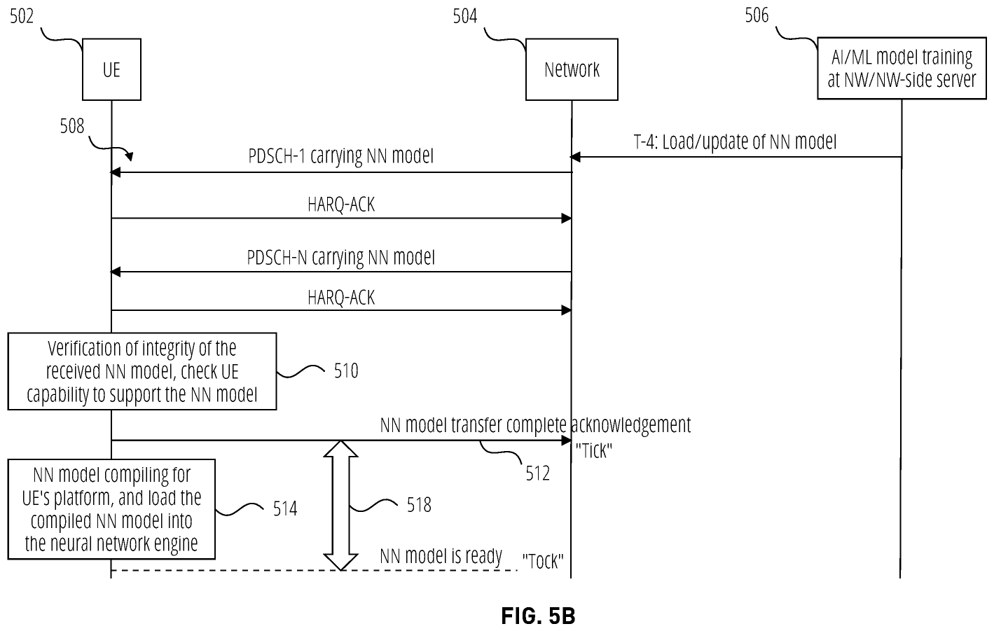

FIG. 5A and FIG. 5B are signaling diagrams illustrating model activation timing according to certain embodiments. These examples use NW-side AI/ML model training 506 (e.g., at a base station or NW-side server), and in a training step T-4 a message is sent from the NW or NW-side server (e.g., to the base station) to load or update the trained NN model. Although not shown, certain embodiments may also include, e.g., the training steps T-0, T-1, T2, and/or T3 shown in FIG. 3 or FIG. 4.

In response to the training step T-4, the network 504 (e.g., the base station) transmits the trained NN model in one or more physical downlink shared channel (PDSCH) 508 to the UE 502. The one or more PDSCH 508 is illustrated by PDSCH-1 to PDSCH-N carrying data corresponding to respective portions of the NN model, wherein the UE 502 confirms successful reception of each portion by sending a hybrid automatic repeat request (HARQ) acknowledgement (ACK) in response to each PDSCH.

After receiving the trained NN model, in block 510, the UE 502 performs a verification of the integrity of the received NN model and checks the UE's capability to support the NN model. If the UE 502 is able to verify the integrity of the NN model and determine that the UE supports the NN model, the UE 502 sends an NN model transfer complete acknowledgement message 512 to the NW-side server. The message 512 may be transparent to the base station (the base station of the network 504 merely forwards the message 512 to the NW-side server). If, on the other hand, the UE 502 determines at block 510 that the integrity of the NN model cannot be verified and/or that the UE 502 is not capable to support the NN model (e.g., it is an incorrect version), the message 512 comprises a negative acknowledgement such that the NW or NW-side server may attempt a different configuration/version or may attempt to train a different NN model. At block 514, the UE 502 performs NN model compiling for the UE's platform and loads the compiled NN model into a NN engine at the UE 502.

In FIG. 5A, after the compiled NN model is loaded into the NN engine, the UE 502 sends a message 516 to the network 504 that the NN model is ready to use. Thus, the network 504 knows when it can start reference signal transmission (including at least Set B) for beam management. See, e.g., inference steps I-1, I-2, I-3, and I-4 in FIG. 2.

In FIG. 5B, rather than sending the NN model transfer complete acknowledgement message 512 to the NW-side server, the UE 502 sends the message 512 to the network 504 (i.e., to the base station). In response to receiving the NN model transfer complete acknowledgement message 512 (shown as a “Tick”), the base station starts a timer corresponding to a time gap 518 based on an expected delay for compiling the NN model and loading it into the NN engine at the UE 502. The time gap 518 may, for example, be derived from UE capability reporting by the UE 502 to the network 504. When the timer expires (shown as a “Tock”), the base station determines that the NN model is ready to use. Thus, the message 516 shown in FIG. 5A is not needed for the network 504 to know when it can start reference signal transmission (including at least Set B) for beam management, which reduces the signaling overhead.

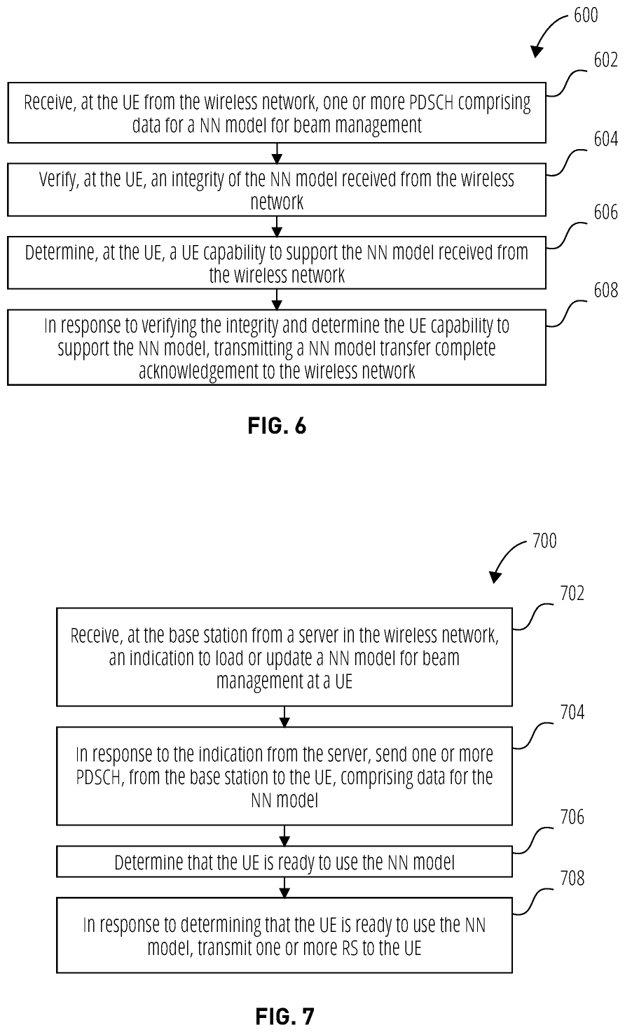

FIG. 6 is a flowchart of a method 600 for a UE to communicate in a wireless network according to one embodiment. In block 602, the method 600 includes receiving, at the UE from the wireless network, one or more PDSCH comprising data for a NN model for beam management. In block 604, the method 600 includes verifying, at the UE, an integrity of the NN model received from the wireless network. In block 606, the method 600 includes determining, at the UE, a UE capability to support the NN model received from the wireless network. In block 608, in response to verifying the integrity and determines the UE capability to support the NN model, the method 600 includes transmitting a NN model transfer complete acknowledgement to the wireless network.

In certain embodiments, the method 600 further includes: generating a compiled NN model by compiling the data for the NN model for use by the UE; and loading the compiled NN model into a NN engine of the UE.

In certain embodiments of the method 600, transmitting the NN model transfer complete acknowledgement comprises transmitting the NN model transfer complete acknowledgement from the UE to a server of the wireless network through a base station.

In certain embodiments, the method 600 further includes, after loading the compiled NN model into the NN engine of the UE, signaling, from the UE to the base station, that the NN model is ready for use at the UE.

In certain embodiments of the method 600, transmitting the NN model transfer complete acknowledgement comprises transmitting the NN model transfer complete acknowledgement to a base station of the wireless network.

Certain embodiments of the method 600 further include generating the compiled NN model and loading the compiled NN model into the NN engine of the UE within a time gap signaled to the base station in a UE capability report.

In certain embodiments of the method 600, the NN model is trained by the wireless network for a single cell, and the NN model is associated with a physical cell identifier (PCI).

In certain embodiments of the method 600, the NN model is trained by the wireless network for a single cell, and the NN model is associated with multiple transmission reception points (mTRP) in the single cell of the wireless network.

In certain embodiments of the method 600, the NN model is trained by the wireless network for multiple cells with different geographical coverages.

In certain embodiments of the method 600, the NN model is trained by the wireless network for multiple cells associated with a same frequency band.

In certain embodiments, the method 600 further includes using the compiled NN model, at the UE, to derive at least one of a reference signal received power (RSRP) and one or more beam indices.

In certain embodiments, the method 600 further includes receiving, from the wireless network, a configuration to monitor the performance of the NN model.

FIG. 7 is a flowchart of a method 700 for a base station in a wireless network to configure beam management according to one embodiment. In block 702, the method 700 includes receiving, at the base station from a server in the wireless network, an indication to load or update a NN model for beam management at a UE. In block 704, in response to the indication from the server, the method 700 includes sending one or more PDSCH, from the base station to the UE, comprising data for the NN model. In block 706, the method 700 includes determining that the UE is ready to use the NN model. In block 708, in response to determining that the UE is ready to use the NN model, the method 700 includes transmitting one or more reference signal (RS) to the UE.

In certain embodiments, the method 700 further includes: transparently forwarding a NN model transfer complete acknowledgement from the UE to the server in the wireless network; and receiving, at the base station from the UE, a signal indicating that the UE is ready to use the NN model.

In certain embodiments, the method 700 further includes: receiving, at the base station from the UE, a UE capability report indicating a time gap value; receiving, at the base station from the UE, a NN model transfer complete acknowledgement; in response to receiving the NN model transfer complete acknowledgement, starting a timer corresponding to the time gap value; and when the timer expires, determining that the UE is ready to use the NN model.

In certain embodiments of the method 700, the NN model is trained by the server in the wireless network for a single cell, and the NN model is associated with a physical cell identifier (PCI).

In certain embodiments of the method 700, the NN model is trained by the server in the wireless network for a single cell, and the NN model is associated with multiple transmission reception points (mTRP) in the single cell of the wireless network.

In certain embodiments of the method 700, the NN model is trained by the server in the wireless network for multiple cells with different geographical coverages.

In certain embodiments of the method 700, the NN model is trained by the server in the wireless network for multiple cells associated with a same frequency band.

In certain embodiments, the method 700 further includes transmitting, from the base station to the UE, a configuration to monitor the performance of the NN model.

Certain embodiments provide NN model transfer during handover. Conditional handover is used to furnish the UE with a set of configurations for the target cell before handover actually takes place. Similar to conditional handover, embodiments disclosed herein may use the network's prediction to identify a target cell for handover. In response to identifying the target cell, the network starts downloading a NN model configured for the target cell to the UE.

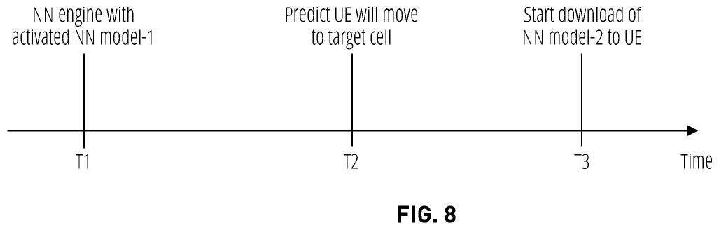

For example, FIG. 8 illustrates a timeline to start downloading a NN model to a UE in anticipation of a handover according to one embodiment. At a first time T1, the UE uses a NN engine with a first activated NN model (NN model-1). At a second time T2, based on reported measurements from the UE, the network predicts that the UE will move from a source cell to a target cell. In response, at a third time T3, the network starts download of a second NN model (NN model-2) to the UE. Thus, because the second NN model is downloaded to the UE before the handover, the delay in activating the second NN model after the handover is reduced.

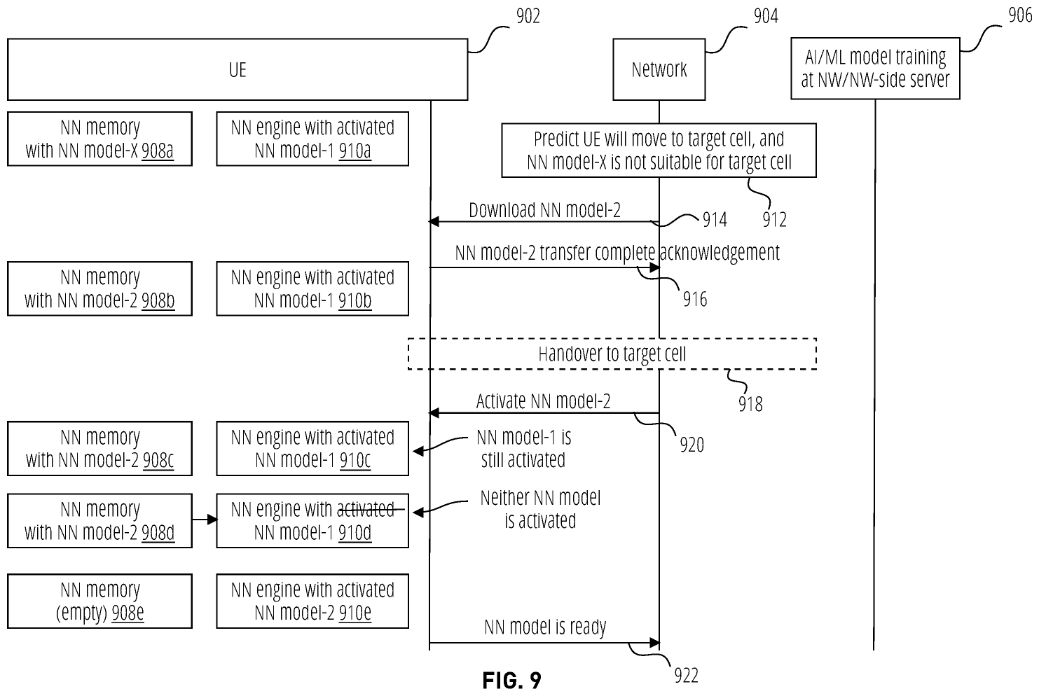

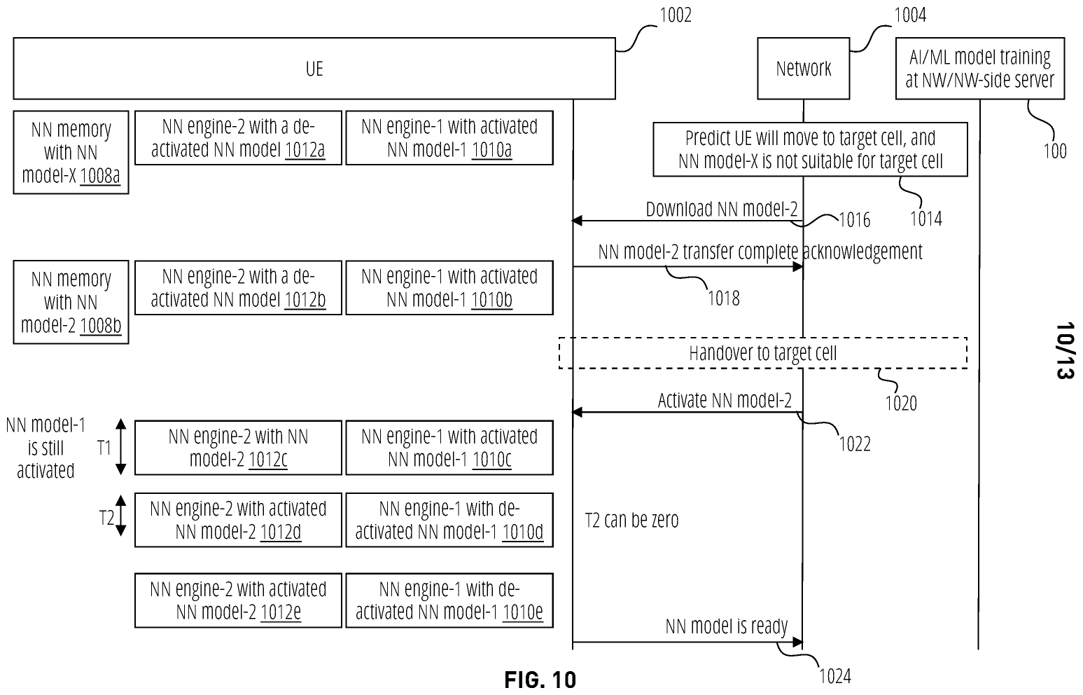

FIG. 9 is a signaling diagram illustrating transfer and activation of a NN model during handover according to one embodiment. In this example, a UE 902 may use a first NN model (NN model-1) in a current or source cell, and a network 904 or a NW-side server may provide AI/ML model training 906. For illustrative purposes, various instances are shown for a NN memory and a NN engine of the UE 902. In other words, the NN memory is shown as different times as NN memory 908a, NN memory 908b, NN memory 908c, NN memory 908d, and NN memory 908e. Similarly, the NN engine is shown as different times as NN engine 910a, NN engine 910b, NN engine 910c, NN engine 910d, and NN engine 910e. For example, at one instance, the NN memory 908a stores an NN model-X and the NN engine 910a operates with the activated NN model-1. Certain embodiments use a single NN engine or a single lane or processing thread in the NN engine. Other embodiments (e.g., see FIG. 10) use multiple NN engines by performing parallel processing using multiple processing cores within a processor of the UE, or using multiple processors at the UE.

The network 904, at block 912, predicts the UE will move to a target cell and determines that the NN model-X is not suitable for the target cell. In response, the network 904 starts 914 to download a second NN model (NN model-2) to the UE 902. For example, the network 904 may transmit one or more PDSCH carrying the NN model-2 to the UE 902 (see FIG. 5A and FIG. 5B). The UE 902 receives and stores the NN model-2 in the NN memory 908b and sends a NN model-2 transfer complete acknowledgement message 916 to the network 904.

At block 918, the network 904 and the UE 902 perform a handover of the UE 902 from the source cell to the target cell. After the handover, the network 904 sends a signal 920 to the UE 902 to activate NN model-2. As shown, at a first instance after receiving the signal 920, the NN memory 908c still stores NN model-2 and NN model-1 is still activated in the NN engine 910c. In response to the signal 920, at a second instance, the UE 902 loads NN model-2 from the NN memory 908d to the NN engine 910d, which deactivates NN model-1. At a third instance, the NN memory 908e is empty and NN mode-2 is activated in the NN engine 910e. The UE 902 may then send a message 922 to the network 904 to report that NN model-2 is ready.

In certain embodiments, a UE can report the support of M activated NN reference models to the network (e.g., in a UE capability message). For inter-band carrier aggregation (CA) or dual connectivity (DC), analog beam forming may be dissimilar for different bands or cell sites. Thus, one reference model may be used as a unit to quantize the complexity of a NN model. For example, NN model-1 may be consider 1X of a reference model, model-2 may be considered 2X of a reference model, etc. Thus, the downloaded models may be quantized as a number of the reference model(s).

FIG. 10 is a signaling diagram illustrating multiple NN engines to transfer and activate a NN model during handover according to one embodiment. Multiple NN engines may be provided, for example, by performing parallel processing using multiple processing cores within a processor of a UE 1002, or using multiple processors at the UE 1002. In the example of FIG. 10, various instances of a first NN engine (NN engine-1) are shown as NN engine-1 1010a, NN engine-1 1010b, NN engine-1 1010c, NN engine-1 1010d, and NN engine-1 1010e. Similarly, various instances of a second NN engine (NN engine-2) are shows as NN engine-2 1012a, NN engine-2 1012b, NN engine-2 1012c, NN engine-2 1012d, and NN engine-2 1012e. Further, different instances are shown for a NN memory as NN memory 1008a and NN memory 1008b.

As shown in FIG. 10, the UE 1002 may use the NN engine-1 1010a with a first NN model (NN model-1) in a current or source cell, at which time the NN engine-2 1012a is with a deactivated NN model and the NN memory 1008a stores NN model-X. A network 1004 or a NW-side server may provide AI/ML model training 1006. The network 1004, at block 1014, predicts the UE 1002 will move to a target cell and determines that the NN model-X is not suitable for the target cell. In response, the network 1004 starts 1016 to download a second NN model (NN model-2) to the UE 1002. For example, the network 1004 may transmit one or more PDSCH carrying the NN model-2 to the UE 1002 (see FIG. 5A and FIG. 5B). The UE 1002 receives and stores the NN model-2 in the NN memory 1008b and sends a NN model-2 transfer complete acknowledgement message 1018 to the network 1004.

At block 1020, the network 1004 and the UE 1002 perform a handover of the UE 1002 from the source cell to the target cell. After the handover, the network 1004 sends a signal 1022 to the UE 1002 to activate NN model-2. As shown, at a first instance (T1) after receiving the signal 1022, the NN engine-1 1010c is still with the activated NN model-1 and the NN engine-2 1012c is with NN model-2 (not yet activated). A second instance (T2) is shown to illustrate that there may be some delay from deactivating NN model-1 in NN engine-1 1010d and activating NN model-2 in NN engine-2 1012d before NN model-2 is ready to use. In certain embodiments, however, T2 can be zero. When NN model-1 is de-activated in NN engine-1 1010e and model-2 is activated in NN engine-2 1012e, the UE 1002 sends a message 1024 to the network 1004 to indicate that NN model-2 is ready.

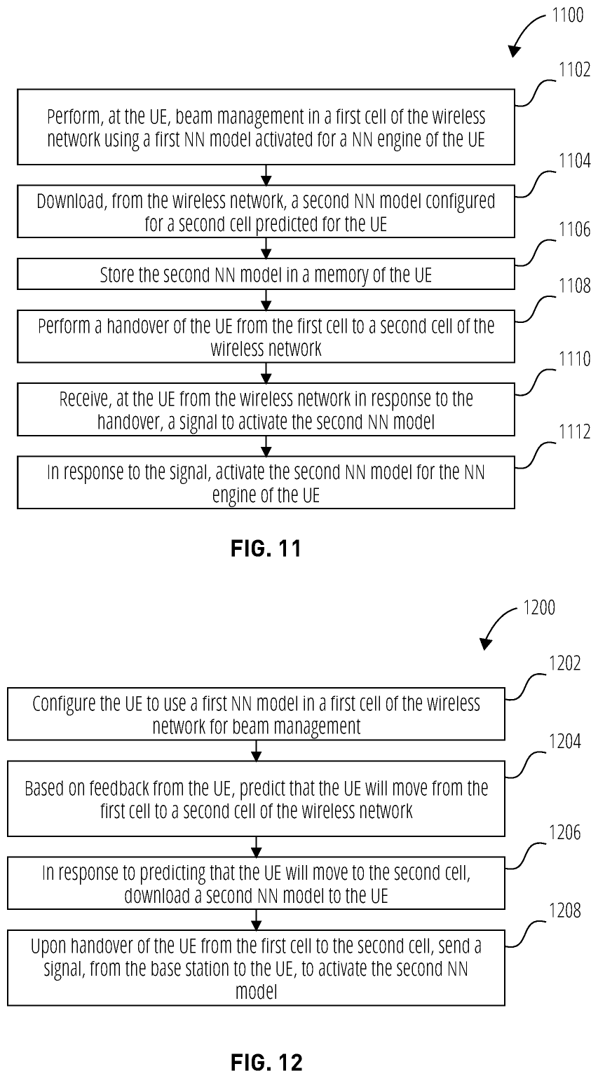

FIG. 11 is a flowchart of a method 1100 for a UE to communicate in a wireless network according to one embodiment. In block 1102, the method 1100 includes performing, at the UE, beam management in a first cell of the wireless network using a first NN model activated for a NN engine of the UE. In block 1104, the method 1100 includes downloading, from the wireless network, a second NN model configured for a second cell predicted for the UE. In block 1106, the method 1100 includes storing the second NN model in a memory of the UE. In block 1108, the method 1100 includes performing a handover of the UE from the first cell to a second cell of the wireless network. In block 1110, the method 1100 includes receiving, at the UE from the wireless network in response to the handover, a signal to activate the second NN model. In block 1112, in response to the signal, the method 1100 includes activating the second NN model for the NN engine of the UE.

In certain embodiments, the method 1100 further includes, in response to downloading the second NN model, transmitting a NN model transfer complete acknowledgement to the wireless network.

In certain embodiments of the method 1100, activating the second NN model in response to the signal from the wireless network comprises: deactivating the first NN model in the NN engine; loading the second NN model from the memory of the UE to the NN engine; and activating the second NN model for use by the NN engine of the UE.

In certain embodiments of the method 1100, the UE is configured for parallel processing, wherein the NN engine comprises a first NN engine of a first process, and wherein activating the second NN model comprises: loading the second NN model from the memory of the UE to a second NN engine of a second process; activating the second NN model for use by the second NN engine; and in response to the signal from the wireless network, switching from the first process to the second process to perform the beam management in the second cell of the wireless network using the second NN model.

In certain embodiments, the method 1100 further includes performing the parallel processing using multiple processing cores within a processor of the UE or using multiple processors at the UE. Certain such embodiments further include reporting, from the UE to the base station, a UE capability to support a number, M, of activated NN reference models, wherein a first NN reference model is used as a unit to quantize a NN model, and wherein the number, M, of activated NN reference models is based at least on one of a size and a complexity of the first NN reference model. The second NN model may be quantified to the first NN reference model, and the quantification may be with regard to complexity and/or memory storage.

FIG. 12 is a flowchart of a method 1200 for a base station to communicate with a UE in a wireless network according to one embodiment. In block 1202, the method 1200 includes configuring the UE to use a first NN model in a first cell of the wireless network for beam management. In block 1204, based on feedback from the UE, the method 1200 includes predicting that the UE will move from the first cell to a second cell of the wireless network. In block 1206, in response to predicting that the UE will move to the second cell, the method 1200 includes downloading a second NN model to the UE. In block 1208, upon handover of the UE from the first cell to the second cell, the method 1200 includes sending a signal, from the base station to the UE, to activate the second NN model.

In certain embodiments of the method 1200, downloading the second NN model to the UE is further in response to determining that the first NN model or a third NN model stored by the UE is not configured for the second wireless network.

In certain embodiments, the method 1200 further includes receiving, at the base station from the UE, a signal indicating that the second NN model is ready for use at the UE.

In certain embodiments, the method 1200 further includes: receiving, at the base station from the UE, a UE capability report indicating a time gap value; receiving, at the base station from the UE, a NN model transfer complete acknowledgement; in response to receiving the NN model transfer complete acknowledgement, starting a timer corresponding to the time gap value; and when the timer expires, determining that the UE is ready to use the NN model.

In certain embodiments, the method 1200 further includes: receiving, from the UE at the base station, a UE capability report indicating support of a number, M, of activated NN reference models, wherein a first NN reference model is used as a unit to quantize a NN model; and based on the number, M, of activated NN reference models and at least one of a size and a complexity of the first reference model, select one or more additional NN models to download to the UE, wherein the second NN model and the one or more additional NN models are quantified to the first reference model with regard to complexity and storage.

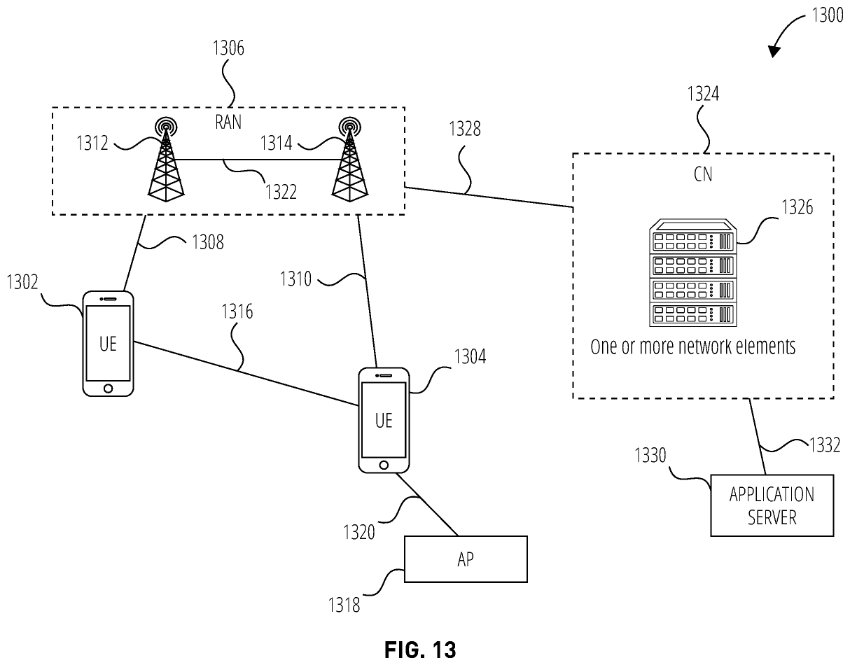

FIG. 13 illustrates an example architecture of a wireless communication system 1300, according to embodiments disclosed herein. The following description is provided for an example wireless communication system 1300 that operates in conjunction with the LTE system standards and/or 5G or NR system standards as provided by 3GPP technical specifications.

As shown by FIG. 13, the wireless communication system 1300 includes UE 1302 and UE 1304 (although any number of UEs may be used). In this example, the UE 1302 and the UE 1304 are illustrated as smartphones (e.g., handheld touchscreen mobile computing devices connectable to one or more cellular networks), but may also comprise any mobile or non-mobile computing device configured for wireless communication.

The UE 1302 and UE 1304 may be configured to communicatively couple with a RAN 1306. In embodiments, the RAN 1306 may be NG-RAN, E-UTRAN, etc. The UE 1302 and UE 1304 utilize connections (or channels) (shown as connection 1308 and connection 1310, respectively) with the RAN 1306, each of which comprises a physical communications interface. The RAN 1306 can include one or more base stations (such as base station 1312 and base station 1314) that enable the connection 1308 and connection 1310.

In this example, the connection 1308 and connection 1310 are air interfaces to enable such communicative coupling, and may be consistent with RAT(s) used by the RAN 1306, such as, for example, an LTE and/or NR.

In some embodiments, the UE 1302 and UE 1304 may also directly exchange communication data via a sidelink interface 1316. The UE 1304 is shown to be configured to access an access point (shown as AP 1318) via connection 1320. By way of example, the connection 1320 can comprise a local wireless connection, such as a connection consistent with any IEEE 802.11 protocol, wherein the AP 1318 may comprise a Wi-Fi® router. In this example, the AP 1318 may be connected to another network (for example, the Internet) without going through a CN 1324.

In embodiments, the UE 1302 and UE 1304 can be configured to communicate using orthogonal frequency division multiplexing (OFDM) communication signals with each other or with the base station 1312 and/or the base station 1314 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 1312 or base station 1314 may be implemented as one or more software entities running on server computers as part of a virtual network. In addition, or in other embodiments, the base station 1312 or base station 1314 may be configured to communicate with one another via interface 1322. In embodiments where the wireless communication system 1300 is an LTE system (e.g., when the CN 1324 is an EPC), the interface 1322 may be an X2 interface. The X2 interface may be defined between two or more base stations (e.g., two or more eNBs and the like) that connect to an EPC, and/or between two eNBs connecting to the EPC. In embodiments where the wireless communication system 1300 is an NR system (e.g., when CN 1324 is a 5GC), the interface 1322 may be an Xn interface. The Xn interface is defined between two or more base stations (e.g., two or more gNBs and the like) that connect to 5GC, between a base station 1312 (e.g., a gNB) connecting to 5GC and an eNB, and/or between two eNBs connecting to 5GC (e.g., CN 1324).

The RAN 1306 is shown to be communicatively coupled to the CN 1324. The CN 1324 may comprise one or more network elements 1326, which are configured to offer various data and telecommunications services to customers/subscribers (e.g., users of UE 1302 and UE 1304) who are connected to the CN 1324 via the RAN 1306. The components of the CN 1324 may be implemented in one physical device or separate physical devices including components to read and execute instructions from a machine-readable or computer-readable medium (e.g., a non-transitory machine-readable storage medium).

In embodiments, the CN 1324 may be an EPC, and the RAN 1306 may be connected with the CN 1324 via an S1 interface 1328. In embodiments, the S1 interface 1328 may be split into two parts, an S1 user plane (S1-U) interface, which carries traffic data between the base station 1312 or base station 1314 and a serving gateway (S-GW), and the S1-MME interface, which is a signaling interface between the base station 1312 or base station 1314 and mobility management entities (MMEs).

In embodiments, the CN 1324 may be a 5GC, and the RAN 1306 may be connected with the CN 1324 via an NG interface 1328. In embodiments, the NG interface 1328 may be split into two parts, an NG user plane (NG-U) interface, which carries traffic data between the base station 1312 or base station 1314 and a user plane function (UPF), and the S1 control plane (NG-C) interface, which is a signaling interface between the base station 1312 or base station 1314 and access and mobility management functions (AMFs)

Generally, an application server 1330 may be an element offering applications that use internet protocol (IP) bearer resources with the CN 1324 (e.g., packet switched data services). The application server 1330 can also be configured to support one or more communication services (e.g., VoIP sessions, group communication sessions, etc.) for the UE 1302 and UE 1304 via the CN 1324. The application server 1330 may communicate with the CN 1324 through an IP communications interface 1332.

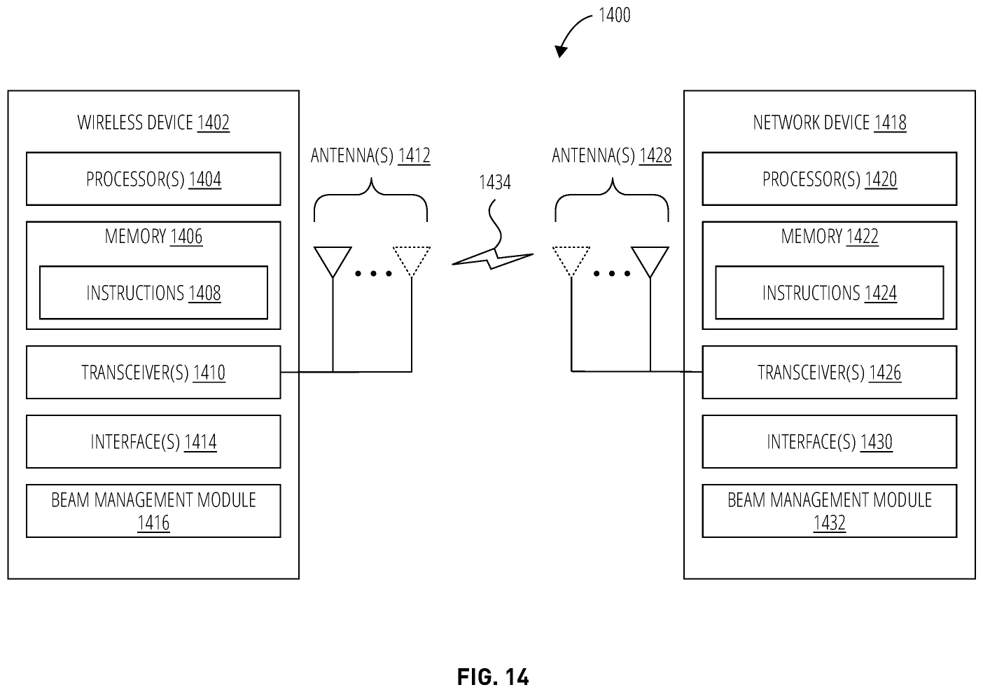

FIG. 14 illustrates a system 1400 for performing signaling 1434 between a wireless device 1402 and a network device 1418, according to embodiments disclosed herein. The system 1400 may be a portion of a wireless communications system as herein described. The wireless device 1402 may be, for example, a UE of a wireless communication system. The network device 1418 may be, for example, a base station (e.g., an eNB or a gNB) of a wireless communication system.

The wireless device 1402 may include one or more processor(s) 1404. The processor(s) 1404 may execute instructions such that various operations of the wireless device 1402 are performed, as described herein. The processor(s) 1404 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1402 may include a memory 1406. The memory 1406 may be a non-transitory computer-readable storage medium that stores instructions 1408 (which may include, for example, the instructions being executed by the processor(s) 1404). The instructions 1408 may also be referred to as program code or a computer program. The memory 1406 may also store data used by, and results computed by, the processor(s) 1404.

The wireless device 1402 may include one or more transceiver(s) 1410 that may include radio frequency (RF) transmitter and/or receiver circuitry that use the antenna(s) 1412 of the wireless device 1402 to facilitate signaling (e.g., the signaling 1434) to and/or from the wireless device 1402 with other devices (e.g., the network device 1418) according to corresponding RATs.

The wireless device 1402 may include one or more antenna(s) 1412 (e.g., one, two, four, or more). For embodiments with multiple antenna(s) 1412, the wireless device 1402 may leverage the spatial diversity of such multiple antenna(s) 1412 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 1402 may be accomplished according to precoding (or digital beamforming) that is applied at the wireless device 1402 that multiplexes the data streams across the antenna(s) 1412 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1402 may implement analog beamforming techniques, whereby phases of the signals sent by the antenna(s) 1412 are relatively adjusted such that the (joint) transmission of the antenna(s) 1412 can be directed (this is sometimes referred to as beam steering).

The wireless device 1402 may include one or more interface(s) 1414. The interface(s) 1414 may be used to provide input to or output from the wireless device 1402. For example, a wireless device 1402 that is a UE may include interface(s) 1414 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 1410/antenna(s) 1412 already described) that allow for communication between the UE and other devices and may operate according to known protocols (e.g., Wi-Fi®, Bluetooth®, and the like).

The wireless device 1402 may include a beam management module 1416. The beam management module 1416 may be implemented via hardware, software, or combinations thereof. For example, the beam management module 1416 may be implemented as a processor, circuit, and/or instructions 1408 stored in the memory 1406 and executed by the processor(s) 1404. In some examples, the beam management module 1416 may be integrated within the processor(s) 1404 and/or the transceiver(s) 1410. For example, the beam management module 1416 may be implemented by a combination of software components (e.g., executed by a DSP or a general processor) and hardware components (e.g., logic gates and circuitry) within the processor(s) 1404 or the transceiver(s) 1410.

The beam management module 1416 may be used for various aspects of the present disclosure, for example, aspects of FIG. 5A, FIG. 5B, FIG. 6, FIG. 8, FIG. 9, and/or FIG. 11. The beam management module 1416 may include, for example, a NN engine, a NN model training and/or inference module, a timer, or other components discussed herein.

The network device 1418 may include one or more processor(s) 1420. The processor(s) 1420 may execute instructions such that various operations of the network device 1418 are performed, as described herein. The processor(s) 1420 may include one or more baseband processors implemented using, for example, a CPU, a DSP, an ASIC, a controller, an FPGA device, another hardware device, a firmware device, or any combination thereof configured to perform the operations described herein.

The network device 1418 may include a memory 1422. The memory 1422 may be a non-transitory computer-readable storage medium that stores instructions 1424 (which may include, for example, the instructions being executed by the processor(s) 1420). The instructions 1424 may also be referred to as program code or a computer program. The memory 1422 may also store data used by, and results computed by, the processor(s) 1420.

The network device 1418 may include one or more transceiver(s) 1426 that may include RF transmitter and/or receiver circuitry that use the antenna(s) 1428 of the network device 1418 to facilitate signaling (e.g., the signaling 1434) to and/or from the network device 1418 with other devices (e.g., the wireless device 1402) according to corresponding RATs.

The network device 1418 may include one or more antenna(s) 1428 (e.g., one, two, four, or more). In embodiments having multiple antenna(s) 1428, the network device 1418 may perform MIMO, digital beamforming, analog beamforming, beam steering, etc., as has been described.

The network device 1418 may include one or more interface(s) 1430. The interface(s) 1430 may be used to provide input to or output from the network device 1418. For example, a network device 1418 that is a base station may include interface(s) 1430 made up of transmitters, receivers, and other circuitry (e.g., other than the transceiver(s) 1426/antenna(s) 1428 already described) that enables the base station to communicate with other equipment in a core network, and/or that enables the base station to communicate with external networks, computers, databases, and the like for purposes of operations, administration, and maintenance of the base station or other equipment operably connected thereto.

The network device 1418 may include a beam management module 1432. The beam management module 1432 may be implemented via hardware, software, or combinations thereof. For example, the beam management module 1432 may be implemented as a processor, circuit, and/or instructions 1424 stored in the memory 1422 and executed by the processor(s) 1420. In some examples, the beam management module 1432 may be integrated within the processor(s) 1420 and/or the transceiver(s) 1426. For example, the beam management module 1432 may be implemented by a combination of software components (e.g., executed by a DSP or a general processor) and hardware components (e.g., logic gates and circuitry) within the processor(s) 1420 or the transceiver(s) 1426.

The beam management module 1432 may be used for various aspects of the present disclosure, for example, aspects of FIG. 5A, FIG. 5B, FIG. 7, FIG. 8, FIG. 9, and/or FIG. 12. The beam management module 1432 may include, for example, a NN model training and/or inference module, a NW-side server, or other components discussed herein.

Embodiments contemplated herein include an apparatus comprising means to perform one or more elements of the method 600 and/or the method 1100. This apparatus may be, for example, an apparatus of a UE (such as a wireless device 1402 that is a UE, as described herein).

Embodiments contemplated herein include one or more non-transitory computer-readable media comprising instructions to cause an electronic device, upon execution of the instructions by one or more processors of the electronic device, to perform one or more elements of the method 600 and/or the method 1100. This non-transitory computer-readable media may be, for example, a memory of a UE (such as a memory 1406 of a wireless device 1402 that is a UE, as described herein).

Embodiments contemplated herein include an apparatus comprising logic, modules, or circuitry to perform one or more elements of the method 600 and/or the method 1100. This apparatus may be, for example, an apparatus of a UE (such as a wireless device 1402 that is a UE, as described herein).

Embodiments contemplated herein include an apparatus comprising: one or more processors and one or more computer-readable media comprising instructions that, when executed by the one or more processors, cause the one or more processors to perform one or more elements of the method 600 and/or the method 1100. This apparatus may be, for example, an apparatus of a UE (such as a wireless device 1402 that is a UE, as described herein).

Embodiments contemplated herein include a signal as described in or related to one or more elements of the method 600 and/or the method 1100.

Embodiments contemplated herein include a computer program or computer program product comprising instructions, wherein execution of the program by a processor is to cause the processor to carry out one or more elements of the method 600 and/or the method 1100. The processor may be a processor of a UE (such as a processor(s) 1404 of a wireless device 1402 that is a UE, as described herein). These instructions may be, for example, located in the processor and/or on a memory of the UE (such as a memory 1406 of a wireless device 1402 that is a UE, as described herein).

Embodiments contemplated herein include an apparatus comprising means to perform one or more elements of the method 700 and/or the method 1200. This apparatus may be, for example, an apparatus of a base station (such as a network device 1418 that is a base station, as described herein).

Embodiments contemplated herein include one or more non-transitory computer-readable media comprising instructions to cause an electronic device, upon execution of the instructions by one or more processors of the electronic device, to perform one or more elements of the method 700 and/or the method 1200. This non-transitory computer-readable media may be, for example, a memory of a base station (such as a memory 1422 of a network device 1418 that is a base station, as described herein).

Embodiments contemplated herein include an apparatus comprising logic, modules, or circuitry to perform one or more elements of the method 700 and/or the method 1200. This apparatus may be, for example, an apparatus of a base station (such as a network device 1418 that is a base station, as described herein).

Embodiments contemplated herein include an apparatus comprising: one or more processors and one or more computer-readable media comprising instructions that, when executed by the one or more processors, cause the one or more processors to perform one or more elements of the method 700 and/or the method 1200. This apparatus may be, for example, an apparatus of a base station (such as a network device 1418 that is a base station, as described herein).

Embodiments contemplated herein include a signal as described in or related to one or more elements of the method 700 and/or the method 1200.

Embodiments contemplated herein include a computer program or computer program product comprising instructions, wherein execution of the program by a processing element is to cause the processing element to carry out one or more elements of the method 700 and/or the method 1200. The processor may be a processor of a base station (such as a processor(s) 1420 of a network device 1418 that is a base station, as described herein). These instructions may be, for example, located in the processor and/or on a memory of the base station (such as a memory 1422 of a network device 1418 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method for a user equipment (UE) to communicate in a wireless network, the method comprising:
receiving, at the UE from the wireless network, one or more physical downlink shared channel (PDSCH) comprising data for a neural network (NN) model for beam management;
verifying, at the UE, an integrity of the NN model received from the wireless network;
determining, at the UE, a UE capability to support the NN model received from the wireless network; and
in response to verifying the integrity and determining the UE capability to support the NN model, transmitting a NN model transfer complete acknowledgement to the wireless network.

2. The method of claim 1, further comprising:
generating a compiled NN model by compiling the data for the NN model for use by the UE; and
loading the compiled NN model into a NN engine of the UE.

3. The method of claim 2, wherein transmitting the NN model transfer complete acknowledgement comprises transmitting the NN model transfer complete acknowledgement from the UE to a server of the wireless network through a base station.

4. The method of claim 3, further comprising, after loading the compiled NN model into the NN engine of the UE, signaling, from the UE to the base station, that the NN model is ready for use at the UE.

5. The method of claim 2, wherein transmitting the NN model transfer complete acknowledgement comprises transmitting the NN model transfer complete acknowledgement to a base station of the wireless network.

6. The method of claim 2, further comprising generating the compiled NN model and loading the compiled NN model into the NN engine of the UE within a time gap signaled to a base station in a UE capability report.

7. The method of claim 1, wherein the NN model is trained by the wireless network for a single cell of the wireless network, and wherein the NN model is associated with a physical cell identifier (PCI).

8. The method of claim 1, wherein the NN model is trained by the wireless network for a single cell of the wireless network, and wherein the NN model is associated with multiple transmission reception points (mTRP) in the single cell of the wireless network.

9. The method of claim 1, wherein the NN model is trained by the wireless network for multiple cells with different geographical coverages.

10. The method of claim 1, wherein the NN model is trained by the wireless network for multiple cells associated with a same frequency band.

11. The method of claim 1, further comprising using a compiled NN model, at the UE, to derive at least one of a reference signal received power (RSRP) and one or more beam indices.

12. The method of claim 1, further comprising receiving, from the wireless network, a configuration to monitor a performance of the NN model.

13. A method for a base station in a wireless network to configure beam management, the method comprising:
receiving, at the base station from a server in the wireless network, an indication to load or update a neural network (NN) model for beam management at a user equipment (UE);
in response to the indication from the server, sending one or more physical downlink shared channel (PDSCH), from the base station to the UE, comprising data for the NN model;
determining that the UE is ready to use the NN model; and
in response to determining that the UE is ready to use the NN model, transmitting one or more reference signal (RS) to the UE.

14. The method of claim 13, further comprising:
transparently forwarding a NN model transfer complete acknowledgement from the UE to the server in the wireless network; and
receiving, at the base station from the UE, a signal indicating that the UE is ready to use the NN model.

15. The method of claim 13, further comprising:
receiving, at the base station from the UE, a UE capability report indicating a time gap value;
receiving, at the base station from the UE, a NN model transfer complete acknowledgement;
in response to receiving the NN model transfer complete acknowledgement, starting a timer corresponding to the time gap value; and
when the timer expires, determining that the UE is ready to use the NN model.

16. The method of claim 13, wherein the NN model is trained by the server in the wireless network for a single cell of the wireless network, and wherein the NN model is associated with a physical cell identifier (PCI).

17. The method of claim 13, wherein the NN model is trained by the server in the wireless network for a single cell of the wireless network, and wherein the NN model is associated with multiple transmission reception points (mTRP) in the single cell of the wireless network.

18. The method of claim 13, wherein the NN model is trained by the server in the wireless network for multiple cells with different geographical coverages.

19. The method of claim 13, wherein the NN model is trained by the server in the wireless network for multiple cells associated with a same frequency band.

20. The method of claim 13, further comprising transmitting, from the base station to the UE, a configuration to monitor a performance of the NN model.

21-23. (canceled)
